(19) United States
(12) Patent Application Publication
(10) Pub. No.: US 2025/0380207 A1
(43) Pub. Date: Dec. 11, 2025

(54) RADIO COMMUNICATION SYSTEM, RADIO COMMUNICATION METHOD, AND BASE STATION APPARATUS

(71) Applicant: NIPPON TELEGRAPH AND TELEPHONE CORPORATION, Tokyo (JP)

(72) Inventors: Takeru FUKUSHIMA, Tokyo (JP); Motoharu SASAKI, Tokyo (JP); Toshiro NAKAHIRA, Tokyo (JP); Daisuke MURAYAMA, Tokyo (JP); Takatsune MORIYAMA, Tokyo (JP)

(21) Appl. No.: 18/874,814

(22) PCT Filed: Jun. 17, 2022
(86) PCT No.: PCT/JP2022/024424

§ 371 Date: Dec. 13, 2024

(51) Int. Cl. H04W 48/10

(52) U.S. Cl. CPC H04W 48/10

(57) ABSTRACT

Provided is a wireless communication system including a plurality of base station devices, in which the base station device includes: a management unit configured to manage information regarding connection with a terminal device by using a blockchain shared by the plurality of base station devices; an acquisition unit configured to acquire, from wireless signals broadcast by other base station devices, information of one or more first base station devices in a vicinity of the base station device among the plurality of base station devices; an extraction unit configured to extract, from ledger information of the blockchain, information of one or more second base station devices, among the plurality of base station devices, from or to which the terminal device is likely to transition to or from the first base station device; and a determination unit configured to acquire connection conditions of the first base station device and the second base station device from the ledger information of the blockchain, and determine a connection condition of the base station device on the basis of the acquired connection conditions.

### TECHNICAL FIELD

The present invention relates to a wireless communication system, a wireless communication method, and a base station device.

### BACKGROUND ART

In control of connection between a base station device and a terminal device, there is a wireless communication system that uses a blockchain technology to perform, in a distributed manner, processing of the control of connection. For example, there is known a technology in which a base station device controls a connection condition of the own device on the basis of transition information of terminal devices between base station devices acquired from ledger information of a blockchain shared with another base station device, the number of terminal devices connected to each base station device, and the like (see, for example, Non Patent Literature 1).

### CITATION LIST

### Non Patent Literature

Non Patent Literature 1: Takeru Fukushima, et al., “Smoothing Method of User Terminal Accommodation for Blockchain Based Wireless Network Sharing”, IEICE Technical Report, RCS2021-194 (2021-12)

### SUMMARY OF INVENTION

### Technical Problem

However, in a conventional technology, it has been difficult for a new base station device or the like that does not have a sufficient amount of past contract information of the own device accumulated in a blockchain to determine a connection condition of the own device.

An embodiment of the present invention has been made in view of the above problem, and allows a base station device that does not have a sufficient amount of past contract information of the own device accumulated in a blockchain to easily determine a connection condition of the own device.

### Solution to Problem

In order to solve the above problem, a wireless communication system according to an embodiment of the present invention is a wireless communication system including a plurality of base station devices, in which the base station device includes: a management unit configured to manage information regarding connection with a terminal device by using a blockchain shared by the plurality of base station devices; an acquisition unit configured to acquire, from wireless signals broadcast by other base station devices, information of one or more first base station devices in a vicinity of the base station device among the plurality of base station devices; an extraction unit configured to extract, from ledger information of the blockchain, information of one or more second base station devices, among the plurality of base station devices, from or to which the terminal device is likely to transition to or from the first base station device; and a determination unit configured to acquire connection conditions of the first base station device and the second base station device from the ledger information of the blockchain, and determine a connection condition of the base station device on the basis of the acquired connection conditions.

### Advantageous Effects of Invention

According to the embodiment of the present invention, a base station device that does not have a sufficient amount of past contract information of the own device accumulated in a blockchain can easily determine a connection condition of the own device.

### BRIEF DESCRIPTION OF DRAWINGS

FIG. 1 is a diagram illustrating an example of a system configuration of a wireless communication system according to the present embodiment.

FIG. 2 is a diagram illustrating an example of a blockchain network according to the present embodiment.

FIG. 3 is a diagram illustrating an example of a functional configuration of a base station device according to the present embodiment.

FIG. 4 is a flowchart illustrating an example of processing of the base station device according to the present embodiment.

FIG. 5 is a diagram (1) for illustrating the processing of the base station device according to the present embodiment.

FIG. 6 is a diagram (2) for illustrating the processing of the base station device according to the present embodiment.

FIG. 7 is a diagram (3) for illustrating the processing of the base station device according to the present embodiment.

FIG. 8 is a diagram illustrating an example of a hardware configuration of the base station device according to the present embodiment.

FIG. 9 is a diagram for illustrating an outline of processing of a wireless communication system using a blockchain.

FIG. 10 is a diagram for illustrating a problem for the wireless communication system using the blockchain.

### DESCRIPTION OF EMBODIMENTS

An embodiment of the present invention (present embodiment) will be described below with reference to the drawings. The embodiment to be described below is merely an example, and embodiments to which the present invention is applied are not limited to the following embodiment.

### <Outline>

First, an outline of a wireless communication system using a blockchain, which is the premise of the present embodiment, will be described. The wireless communication system is a system in which, at the time of processing of connection between a base station device (wireless base station) and a terminal device (user terminal), the terminal device can be connected to the base station device by performing connection processing in a distributed manner using the blockchain technology, without centralized management.

### (Outline of Processing)

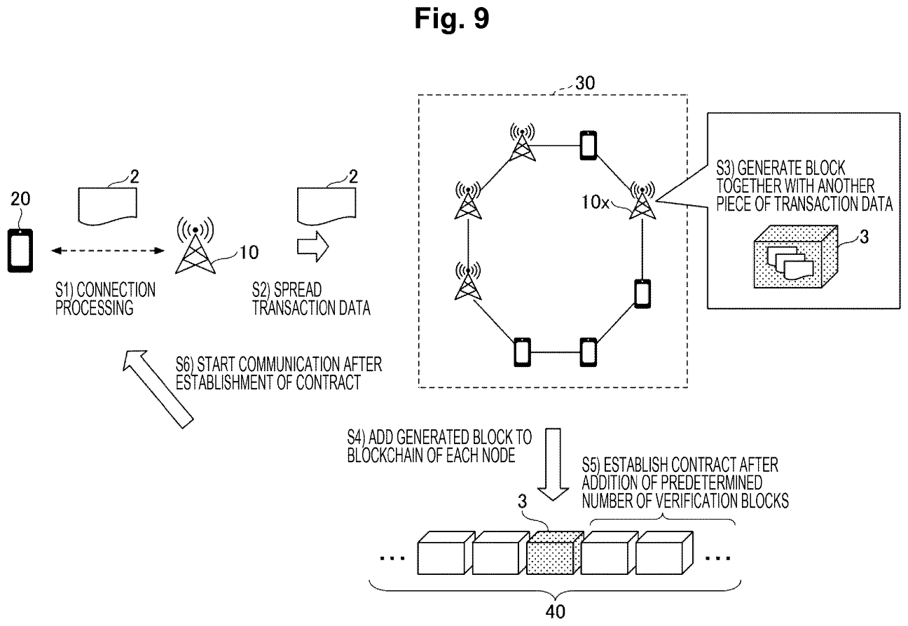

FIG. 9 is a diagram for illustrating an outline of processing of the wireless communication system using a blockchain. In the wireless communication system, in connection processing in which a terminal device 20 is connected to a base station device 10, transaction data 2 is created between the base station device 10 and the terminal device 20 (step S1). For example, the terminal device 20 receives a connection condition broadcast by the base station device 10, and checks communication qualities, a connection cost, and the like of a wireless communication network provided by the base station device 10. On the other hand, the base station device 10 checks, for example, whether the terminal device 20 has sufficient payment ability. In a case where an agreement on the connection condition between the base station device 10 and the terminal device 20 is obtained, the base station device 10 records the contents of the agreement in the transaction data 2.

The communication qualities of the wireless communication network provided by the base station device 10 include, for example, throughput, a total data amount, or the like. The terminal device 20 may agree with the connection condition in a case where the communication qualities provided by the base station device 10 satisfy all the communication qualities requested by the terminal device 20. Alternatively, the terminal device 20 may agree with the connection condition in a case where the communication qualities provided by the base station device 10 satisfy some of the communication qualities requested by the terminal device 20.

The base station device 10 spreads the transaction data 2 created in the connection processing to nodes participating in a blockchain network 30 (step S2). The blockchain network 30 includes a plurality of nodes that collectively records the transaction data 2 on a block-by-block basis and shares a blockchain (distributed ledger) in which a plurality of blocks are recorded in time series. The plurality of nodes include, for example, a plurality of the base station devices 10 constituting the wireless communication system. The plurality of nodes may include nodes (e.g., computers or terminal devices) other than the base station devices 10.

When the blockchain network 30 is notified of the transaction data 2, some nodes (e.g., a base station device 10x) participating in the blockchain network 30 generate a block 3 together with another piece of transaction data (step S3). After generating the block 3, the blockchain network 30 adds the generated block 3 to a blockchain 40 of each node included in the blockchain network 30 (step S4).

The blockchain 40 of each node retains the added block, and after a predetermined number of blocks (verification blocks) have been further added to the blockchain, the block being retained is accepted, and thus a contract is established (step S5). After establishment of the contract, the base station device 10 starts communication with the terminal device 20 (step S6).

By performing the above processing, the wireless communication system can execute processing of connection between the base station device 10 and the terminal device 20 by performing control in a distributed manner without depending on a control station or the like that performs centralized control on the wireless communication system.

### (Problems)

In the wireless communication system described above, the terminal device 20 checks connection conditions transmitted by one or more base station devices 10 and determines a base station device 10 to which a request for connection is to be made, which is a control procedure led by the terminal device (user terminal) 20.

However, in the case of the control procedure led by the terminal device 20, the terminal devices 20 may tend to be connected to a specific base station device 10, and this may decrease wireless resource utilization efficiency of the entire wireless communication system.

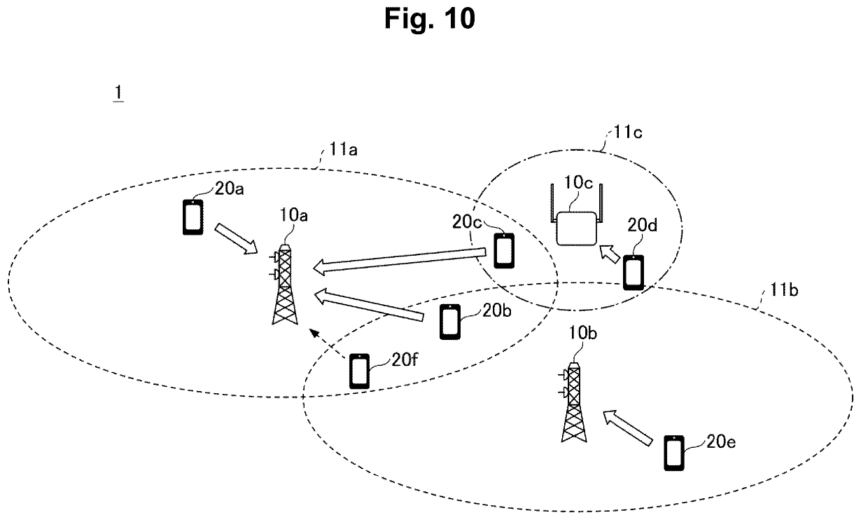

FIG. 10 is a diagram for illustrating a problem for the wireless communication system using the blockchain. In the example in FIG. 10, a wireless communication system 1 includes a plurality of base station devices 10a, 10b, and 10c as an example for illustration.

In FIG. 10, the base station device 10a forms a network cell 11a, and can communicate with terminal devices 20a, 20b, 20c, and 20f in the network cell 11a. The base station device 10b forms a network cell 11b, and can communicate with the terminal devices 20b, 20e, and 20f in the network cell 11b. The base station device 10c forms a network cell 11c, and can communicate with the terminal devices 20c and 20d in the network cell 11c.

In a case where each terminal device 20 autonomously determines a base station device 10 as a connection destination, for example, as illustrated in FIG. 10, the terminal devices 20a, 20b, and 20c to be connected may flock to a specific base station device 10a. On top of this, when the terminal device 20f newly starts communication and is, for example, connected to the base station device 10a that is closer, this may further decrease the wireless resource utilization efficiency of the entire wireless communication system 1.

Thus, a base station device disclosed in Non Patent Literature 1 extracts, from ledger information of a blockchain, one or more other base station devices (hereinafter referred to as a transition BS group) from or to which a terminal device is likely to transition to or from that base station device. The base station device controls the connection cost of the base station device so as to smooth the number of accommodated terminal devices between the base station device and the transition BS group. For example, in a case where the number of terminal devices connected to the base station device is larger than the number of terminal devices connected to other base station devices included in the transition BS group, the base station device increases the connection cost of the base station device itself. In a case where the number of terminal devices connected to the base station device is smaller than the number of terminal devices connected to the other base station devices included in the transition BS group, the base station device reduces the connection cost of the base station device itself.

However, in order to apply the technology disclosed in Non Patent Literature 1 to the base station device, a sufficient amount of the transaction data 2 (hereinafter referred to as contract information) of the base station device is required in the blockchain. However, for example, there is a problem in that the technology disclosed in Non Patent Literature 1 cannot be applied to a base station device or the like in an early stage of introduction that has been newly introduced in a wireless communication system because a sufficient amount of contract information of the own device has not been accumulated in the blockchain.

Thus, the present embodiment describes a wireless communication system 100 that allows a base station device that does not have a sufficient amount of past contract information of the own device accumulated in a blockchain to easily determine a connection condition of the own device.

### <System Configuration>

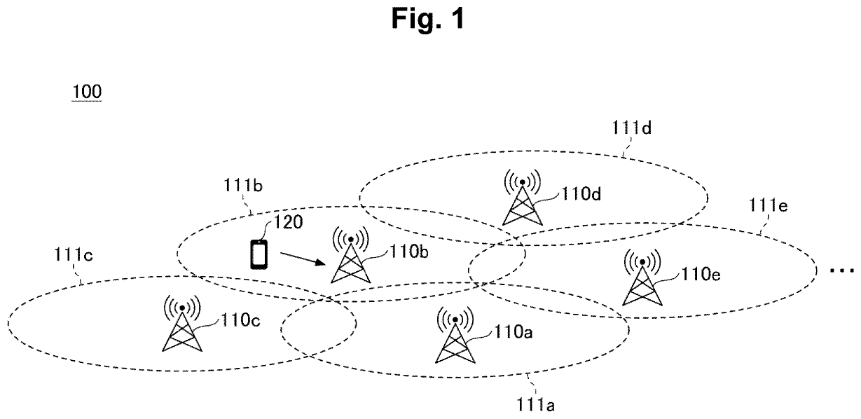

FIG. 1 is a diagram illustrating an example of a system configuration of a wireless communication system according to the present embodiment. As illustrated in FIG. 1, the wireless communication system 100 includes a plurality of base station devices 110a, 110b, 110c, 110d, 110e, . . . , each of which forms a different network cell. For example, the base station device 110a forms a network cell 111a, and can communicate with terminal devices 120 in the network cell 111a. The base station device 110b forms a network cell 111b, and can communicate with the terminal devices 120 in the network cell 111b. Similarly, the base station device 110c forms a network cell 111c, and can communicate with the terminal devices 120 in the network cell 111c. Furthermore, the base station device 110d forms a network cell 111d, and the base station device 110e forms a network cell 111e and can communicate with the terminal devices 120 in the network cell 111e.

In the following description, a “base station device 110” is used to indicate any one of the base station devices 110a, 110b, 110c, 110d, 110e, . . . . Note that the number of base station devices 110 and the number of terminal devices 120 illustrated in FIG. 1 are examples, and may be other numbers.

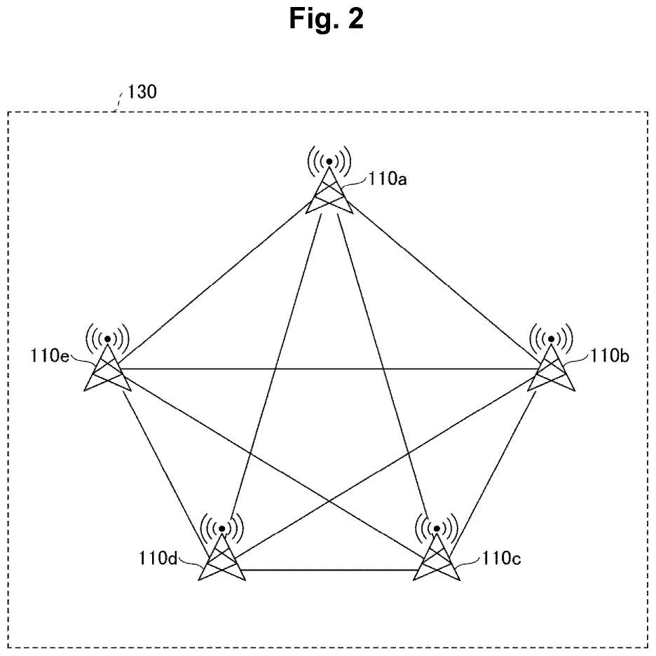

For example, as illustrated in FIG. 2, the plurality of base station devices 110 also function as nodes participating in the blockchain network 30, and the plurality of base station devices 110 share the same blockchain. Here, the blockchain network 30 is a peer-to-peer (P2P) network (distributed network) in which each node can transmit and receive data to and from other nodes, without a server or the like, on an equal footing. The blockchain is an example of a distributed ledger in which a plurality of nodes participating in a P2P network records a transaction or the like between two parties in a verifiable and permanent manner.

The blockchain network 30 may include nodes (e.g., other computers or terminal devices) other than the base station devices 110. Alternatively, the base station devices 110 may not hold a blockchain but request the nodes participating in the blockchain network 30 to perform acquisition, recording, and the like of ledger information.

Each of the base station devices 110 uses a blockchain to manage connection with the terminal devices 120. For example, each of the base station devices 110 records and manages, in a blockchain shared by the plurality of base station devices 110, contract information such as the transaction data 2 described with reference to FIG. 9. Thus, the base station device 110 can refer to the blockchain and acquire information of another base station device 110 (e.g., connection cost of the other base station device 110 or the number of terminal devices 120 connected to the other base station device 110).

### (Outline of Processing)

Here, referring back to FIG. 1, an outline of processing of the wireless communication system 100 according to the present embodiment will be described. Each of the base station devices 110 broadcasts, to the terminal devices 120 in the network cell 111 of the base station device itself, the connection condition for connecting to the base station device itself. The connection condition includes, for example, information such as communication qualities to be provided and the connection cost (provision price) for connection to the base station device 110.

The terminal device 120 that starts communication receives connection conditions transmitted by the base station devices 110 in the vicinity, and determines, on the basis of the connection conditions, a base station device 110 to which a request for connection is to be made. For example, the terminal device 120 determines, as the base station device 110 to which a request for connection is to be made, the base station device 110 that satisfies the communication qualities requested by the terminal device 120 and has the lowest connection cost among one or more base station devices 110 from which the connection conditions have been received.

However, with this method alone, traffic may concentrate on a specific base station device 110 as in the wireless communication system 1 described with reference to FIGS. 9 and 10. Thus, in the technology disclosed in Non Patent Literature 1, a base station device extracts, from ledger information of a blockchain, a transition BS group (one or more other base station devices from or to which a terminal device is likely to transition to or from that base station device). The base station device controls the connection cost of the base station device so as to smooth the number of accommodated terminal devices between the base station device and the transition BS group.

Here, in FIG. 1, the base station device 110a is a base station device in an early stage of introduction that has been newly introduced into the wireless communication system 100, and a sufficient amount of contract information of the base station device 110a has not been accumulated in the blockchain. In this case, the base station device 110a cannot specify other base station devices 110 (transition BS group of the base station device 110a) from or to which the terminal device 120 is likely to transition to or from the base station device 110a by using the ledger information of the blockchain. Therefore, there is a problem in that the base station device 110a cannot determine a connection condition (e.g., connection cost) of the base station device 110a by applying the technology disclosed in Non Patent Literature 1, for example.

Thus, for example, the base station device 110a according to the present embodiment acquires information of the other base station device 110b from a wireless signal that the other base station device 110b broadcasts to the terminal device 120. The base station device 110b is an example of one or more first base station devices in the vicinity of the base station device 110a.

From the ledger information of the blockchain shared by the plurality of base station devices 110, the base station device 110a extracts information of the other base station devices 110 (transition BS group of the base station device 110b) from or to which the terminal device 120 is likely to transition to or from the base station device 110b. For example, the base station device 110a extracts information of the base station devices 110c, 110d, and 110e in FIG. 1 as the transition BS group of the base station device 110b. Here, the base station devices 110c, 110d, and 110e are examples of one or more second base station devices from or to which the terminal device 120 is likely to transition to or from the first base station device (base station device 110b).

Furthermore, the base station device 110a acquires connection conditions of the first base station device and the second base station device (here, base station devices 110b to 110e) from the ledger information of the blockchain, and determines the connection condition of the base station device 110a on the basis of the acquired connection conditions. For example, the base station device 110a acquires the connection costs of the first base station device and the second base station device (base station devices 110b to 110e), and sets, for the base station device 110a, a connection cost lower (cheaper) than the acquired connection costs.

As a result, the base station device 110a is more advantageous in connection cost than the base station device 110b in the vicinity and the base station devices 110c to 110e, which are the transition BS group of the base station device 110b, and can guide the terminal device 120 to the base station device 110a, which is the own device. Therefore, the base station device 110a can quickly accumulate a sufficient amount of contract information necessary for applying a conventional technology as described in Non Patent Literature, and it becomes easy to determine the connection cost of the own device (an example of the connection condition).

### <Functional Configuration>

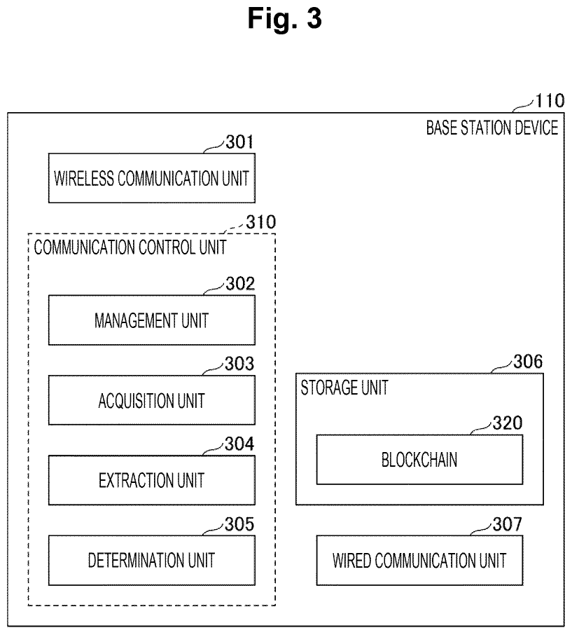

Next, a functional configuration of the base station device 110 according to the present embodiment will be described. FIG. 3 is a diagram illustrating an example of the functional configuration of the base station device according to the present embodiment. The base station device 110 includes, for example, a configuration of a computer, and the computer executes a predetermined program to implement a wireless communication unit 301, a management unit 302, an acquisition unit 303, an extraction unit 304, a determination unit 305, a storage unit 306, a wired communication unit 307, and the like. At least a part of each functional configuration described above may be implemented by hardware.

The wireless communication unit 301 forms the network cell 111 in which wireless communication with the base station device 110 is possible, and executes wireless communication processing of performing wireless communication with the terminal device 120 connected to the base station device 110.

The management unit 302 executes management processing of managing information regarding a contract (information regarding connection) with the terminal device 120 connected to the base station device 110 on the basis of the connection condition broadcast by the base station device 110 by using the blockchain shared by the plurality of base station devices 110. For example, the management unit 302 executes a series of processing described in steps S1 to S6 in FIG. 9 with the terminal device 120 that makes a request for connection to the base station device 110, thereby recording the contract information of the terminal device 120 in a blockchain 320 shared with the other base station devices 110.

As a node of the blockchain shared by the plurality of base station devices 110, the management unit 302 executes various types of processing for managing the blockchain. Similar processing is also executed in the other base station devices 110, and thus the contract information of the terminal devices 120 connected to the base station devices 110 in the wireless communication system 100 is recorded in the blockchain 320. Therefore, the base station device 110 can refer to the blockchain 320 to refer to the information regarding the contracts with the terminal devices 120 connected to the other base station devices 110.

The acquisition unit 303 acquires information of one or more first base station devices in the vicinity of the own device among the plurality of base station devices 110 included in the wireless communication system 100 from wireless signals used by the other base station devices 110 to broadcast the connection conditions. For example, the acquisition unit 303 acquires identification information (hereinafter referred to as a base station ID) for identifying the first base station device in the vicinity of the base station device 110.

The extraction unit 304 extracts, from the ledger information of the blockchain shared by the plurality of base station devices 110, information of one or more second base station devices from or to which the terminal device 120 is likely to transition to or from the first base station device. For example, the extraction unit 304 refers to ledger information of the blockchain 320 stored in the storage unit 306, and extracts base station IDs of one or more second base station devices from or to which the terminal device 120 has ever transitioned to or from the first base station device in the past.

The determination unit 305 acquires, from the ledger information of the blockchain shared by the plurality of base station devices 110, the connection conditions of the first base station device and the second base station device, and determines the connection condition of the own device (base station device 110) on the basis of the acquired connection conditions. For example, the determination unit 305 acquires the connection costs of the first base station device and the second base station device from the ledger information of the blockchain 320 stored in the storage unit 306, and sets, for the own device, a connection cost lower (cheaper) than the acquired connection costs.

Here, the connection costs are costs for the terminal device 120 to connect to the base station devices 110 (e.g., connection fees), and the terminal device 120 preferentially connects to a base station device 110 with the lowest connection cost among the base station devices 110 that satisfy necessary communication qualities, for example.

Transmission power can be reduced in a case where the distance between the base station device 110 and the terminal device 120 is short, and the communication time can be shortened in a case where the speed of communication between the base station device 110 and the terminal device 120 is high. Therefore, the terminal device 120 may determine the base station device 110 to be connected in consideration of the strength of a received signal from the base station device 110, the speed of communication, or the like in addition to the connection cost.

The management unit 302, the acquisition unit 303, the extraction unit 304, and the determination unit 305 are included in, for example, a communication control unit 310 that controls wireless communication by the wireless communication unit 301.

The storage unit 306 executes, for example, storage processing of storing, in a storage device or the like included in the base station device 110, various types of data, information, programs, and the like including the blockchain 320.

The wired communication unit 307 connects the base station device 110 to, for example, a wired communication network, and executes communication related to a blockchain network 130 as illustrated in FIG. 2.

Note that the functional configuration of the base station device 110 illustrated in FIG. 3 is an example. For example, the storage unit 306 may be configured by a computer outside the base station device 110. The management unit 302 may use a predetermined node constituting the blockchain network 130 shared by the plurality of base station devices 110 to write ledger information to the blockchain, read ledger information, and the like.

### <Flow of Processing>

Next, a flow of processing of a wireless communication method according to the present embodiment will be described.

### (Processing of Base Station Device)

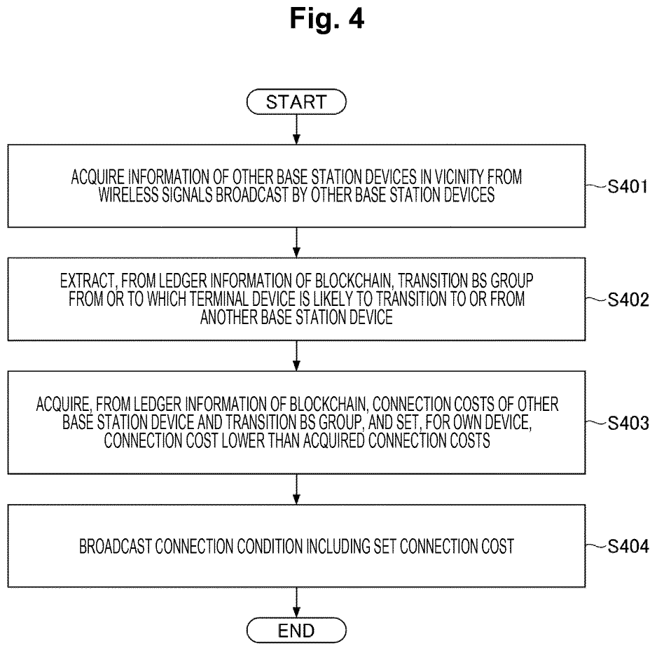

FIG. 4 is a flowchart illustrating a flow of processing of the base station device according to the present embodiment. This processing is an example of processing executed by the base station device 110 (e.g., the base station device 110a in FIG. 1), which has been newly introduced into the wireless communication system 100 and does not have a sufficient amount of contract information (information regarding connection) of the own device accumulated in the blockchain 320, for example.

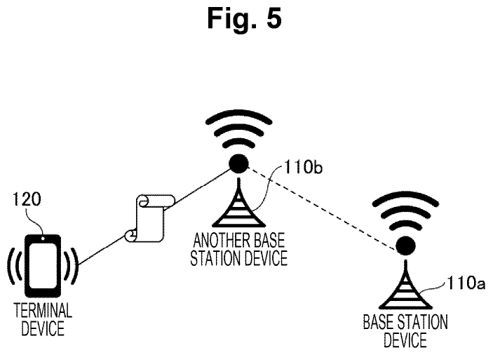

In step S401, the acquisition unit 303 of the base station device 110 acquires information of the other base station devices 110 in the vicinity of the base station device 110 from wireless signals broadcast by the other base station devices 110. For example, the base station device 110a newly introduced into the wireless communication system 100 as illustrated in FIG. 1 acquires, from a wireless signal when the other base station device 110b in the vicinity starts processing of a contract with the terminal device 120, the base station ID and the like of that base station device 110b as illustrated in FIG. 5. The other base station device 110b is an example of the first base station device.

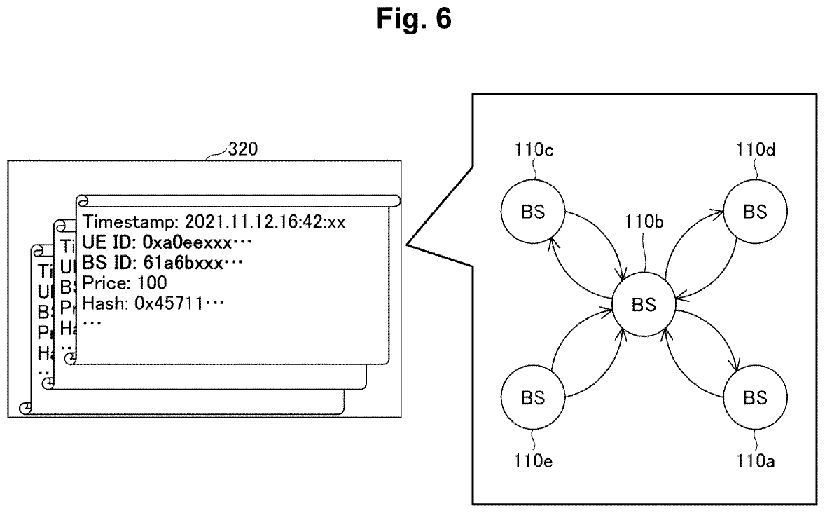

In step S402, the extraction unit 304 of the base station device 110 extracts, from the ledger information of the blockchain 320, a transition BS group from or to which the terminal device is likely to transition to or from another base station device (e.g., base station device 110b). For example, as illustrated in FIG. 6, the extraction unit 304 of the base station device 110a refers to past contract information stored in the blockchain 320, and extracts, for example, the base station devices 110c, 110d, and 110e in FIG. 1 as a transition BS group from or to which the terminal device 120 has ever transitioned to or from the other base station device 110b. The base station devices 110c, 110d, and 110e are examples of one or more second base station devices.

In step S403, the determination unit 305 of the base station device 110 acquires, from the ledger information of the blockchain 320, connection costs of the other base station device (base station device 110b) and the transition BS group (base station devices 110c, 110d, and 110e). The determination unit 305 sets (determines), for the own device (base station device 110a), a connection cost lower than the acquired connection costs.

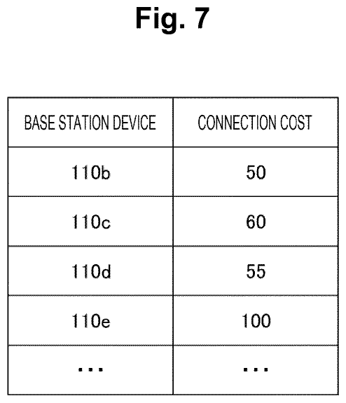

For example, as illustrated in FIG. 7, the connection costs of the base station devices 110b, 110c, 110d, and 110e are “50”, “60”, “55”, and “100”, respectively. In this case, the determination unit 305 of the base station device 110a sets the connection cost of the base station device 110a to “49 or less”, which is lower than the lowest value “50”.

In step S404, the communication control unit 310 of the base station device 110 uses the wireless communication unit 301 to broadcast the connection condition including the set connection cost by wireless communication.

By the processing in FIG. 4, the base station device 110a newly introduced into the wireless communication system 100 can set a lower connection cost than the other base station device 110b in the vicinity and the base station devices 110c to 110e, which are the transition BS group of the other base station device 110b. As a result, the base station device 110a becomes more advantageous in connection cost than the other base station devices 110b to 110e in the vicinity, and can guide the terminal device 120 to the own device (base station device 110a). Therefore, the base station device 110a can quickly accumulate a sufficient amount of contract information, which has been required in a conventional technology as described in Non Patent Literature 1, for example.

As described above, according to the present embodiment, the base station device 110 that does not have a sufficient amount of past contract information of the own device accumulated in a blockchain can easily determine the connection condition of the own device.

In the present embodiment, the base station device 110a can set the connection cost of the own device on the basis of the connection costs of the other base station devices 110b to 110e in the vicinity, and thus, it is possible to prevent a connection cost lower than necessary from being set for the own device.

### <Hardware Configuration>

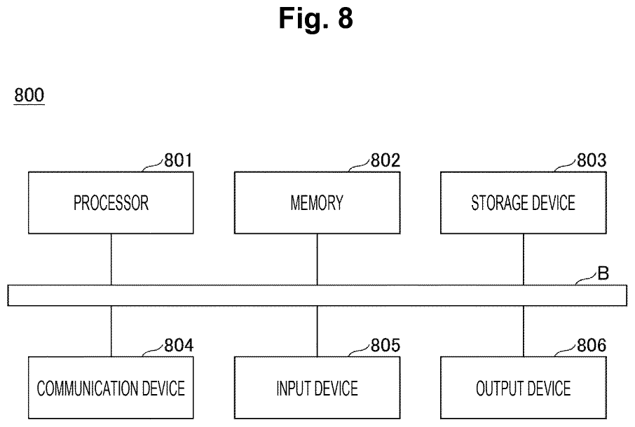

FIG. 8 is a diagram illustrating an example of a hardware configuration of the base station device according to the present embodiment. The base station device 110 has, for example, a configuration of a computer 800 as illustrated in FIG. 8. In the example in FIG. 8, the computer 800 includes a processor 801, a memory 802, a storage device 803, a communication device 804, an input device 805, an output device 806, a bus B, and the like.

The processor 801 is, for example, an arithmetic device such as a central processing unit (CPU) that implements various functions by executing a predetermined program. The memory 802 is a storage medium readable by the computer 800, and includes, for example, a random access memory (RAM) or a read only memory (ROM). The storage device 803 is a computer-readable storage medium, and can include, for example, a hard disk drive (HDD), a solid state drive (SSD), various optical discs, and a magneto-optical disk.

The communication device 804 includes one or more pieces of hardware (communication devices) for communicating with other devices via a wireless or wired network. For example, the communication device 804 of the computer 800 included in the base station device 110 includes a communication device for performing wireless communication and a communication device for performing wired communication.

The input device 805 is an input device (e.g., a keyboard, a mouse, a microphone, a switch, a button, or a sensor) that receives an input from the outside. The output device 806 is an output device (e.g., a display, a speaker, or an LED lamp) that performs output to the outside. The input device 805 and the output device 806 may be integrated (e.g., an input/output device such as a touchscreen display).

The bus B is commonly connected to the above-described components, and transmits, for example, an address signal, a data signal, and various control signals. The processor 801 is not limited to a CPU, and may be, for example, a digital signal processor (DSP), a programmable logic device (PLD), or a field programmable gate array (FPGA).

### (Supplement)

The base station device 110 in the present embodiment is not limited to implementation by a dedicated device, and may be implemented by a general-purpose computer. In that case, a program for implementing the functions may be recorded in a computer-readable recording medium, and the functions may be implemented by loading the program recorded in this recording medium to a computer system, and executing the program. Note that the “computer system” referred to herein includes an OS and hardware such as peripheral equipment.

The “computer-readable recording medium” includes various storage devices such as a portable medium such as a flexible disk, a magneto-optical disk, a ROM, and a CD-ROM, and a hard disk built in the computer system. Furthermore, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case.

In addition, the program may be for implementing some of the above-described functions, may be capable of implementing the above-described functions in combination with a program already recorded in a computer system, or may be implemented by using hardware such as a programmable logic device (PLD) or a field programmable gate array (FPGA).

### Effects of Embodiment

In the wireless communication system 100 according to the present embodiment, the base station device 110 can set a lower price of provision (connection cost) than the other base station devices 110 signals of which have been observed and the transition BS group thereof. As a result, the base station device 110 becomes more advantageous in price than the other base station devices 110 in the surroundings, and can guide the terminal device 120 to the own device. As a result, the base station device 110 can quickly accumulate a sufficient amount of contract information, which has been required in conventional technologies.

### Summary of Embodiment

The present specification discloses at least the wireless communication method and the wireless communication system in the following clauses.

### (Clause 1)

A wireless communication system including a plurality of base station devices, in which
the base station device includes:
a management unit configured to manage information regarding connection with a terminal device by using a blockchain shared by the plurality of base station devices;
an acquisition unit configured to acquire, from wireless signals broadcast by other base station devices, information of one or more first base station devices in a vicinity of the base station device among the plurality of base station devices;
an extraction unit configured to extract, from ledger information of the blockchain, information of one or more second base station devices, among the plurality of base station devices, from or to which the terminal device is likely to transition to or from the first base station device; and
a determination unit configured to acquire connection conditions of the first base station device and the second base station device from the ledger information of the blockchain, and determine a connection condition of the base station device on the basis of the acquired connection conditions.

### (Clause 2)

The wireless communication system according to clause 1, in which the determination unit acquires connection costs of the first base station device and the second base station device from the ledger information of the blockchain, and sets, for the base station device, a connection cost lower than the acquired connection costs.

### (Clause 3)

The wireless communication system according to clause 2, in which, when the base station device is newly introduced into the wireless communication system, the determination unit sets, for the base station device, a connection cost lower than the acquired connection costs.

### (Clause 4)

The wireless communication system according to clause 2, in which, in a case where there is not a sufficient amount of the information regarding connection of the base station device in the blockchain, the determination unit sets, for the base station device, a connection cost lower than the acquired connection costs.

### (Clause 5)

A wireless communication method, in which
in a wireless communication system including a plurality of base station devices,
the base station device executes:
processing of managing information regarding connection with a terminal device by using a blockchain shared by the plurality of base station devices;
processing of acquiring, from wireless signals broadcast by other base station devices, information of one or more first base station devices in a vicinity of the base station device among the plurality of base station devices;
processing of extracting, from ledger information of the blockchain, information of one or more second base station devices, among the plurality of base station devices, from or to which the terminal device is likely to transition to or from the first base station device; and
processing of acquiring connection conditions of the first base station device and the second base station device from the ledger information of the blockchain, and determining the connection condition of the base station device on the basis of the acquired connection conditions.

### (Clause 6)

A base station device in a wireless communication system including a plurality of the base station devices, the base station device including:
a management unit configured to manage information regarding connection with a terminal device by using a blockchain shared by the plurality of base station devices;
an acquisition unit configured to acquire, from wireless signals broadcast by other base station devices, information of one or more first base station devices in a vicinity of the base station device among the plurality of base station devices;
an extraction unit configured to extract, from ledger information of the blockchain, information of one or more second base station devices, among the plurality of base station devices, from or to which the terminal device is likely to transition to or from the first base station device; and
a determination unit configured to acquire connection conditions of the first base station device and the second base station device from the ledger information of the blockchain, and determine a connection condition of the base station device on the basis of the acquired connection conditions.

While the present embodiment has been described above, the present invention is not limited to such a specific embodiment, and various modifications and changes can be made within the scope of the present invention described in the claims.

### REFERENCE SIGNS LIST

100 Wireless communication system
110, 110a to 110e Base station device
302 Management unit
303 Acquisition unit
304 Extraction unit
305 Determination unit
320 Blockchain

1. A wireless communication system comprising a plurality of base station devices, wherein
each of the base station devices includes:
a memory; and
a processor coupled to the memory and configured to:
manage information regarding connection with a terminal device by using a blockchain shared by the plurality of base station devices;
acquire, from wireless signals broadcast by other base station devices, information of one or more first base station devices, among the plurality of base station devices, in a vicinity of the base station device;
extract, from ledger information of the blockchain, information of one or more second base station devices, among the plurality of base station devices, from or to which the terminal device is likely to transition to or from the one or more first base station devices; and
acquire connection conditions of the one or more first base station devices and the one or more second base station devices from the ledger information of the blockchain, and determine a connection condition of the base station device on the basis of the acquired connection conditions.

2. The wireless communication system according to claim 1, wherein the processor is configured to acquire connection costs of the one or more first base station devices and the one or more second base station devices from the ledger information of the blockchain, and set, for the base station device, a connection cost lower than the acquired connection costs.

3. The wireless communication system according to claim 2, wherein, when a base station device is newly introduced into the wireless communication system, the processor is configured to set, for the newly-introduced base station device, a connection cost lower than the acquired connection costs.

4. The wireless communication system according to claim 2, wherein, in a case where there is not a sufficient amount of the information regarding connection of the base station device in the blockchain, the processor is configured to set, for the base station device, a connection cost lower than the acquired connection costs.

5. A wireless communication method, wherein
in a wireless communication system including a plurality of base station devices,
each of the base station devices executes:
managing information regarding connection with a terminal device by using a blockchain shared by the plurality of base station devices;
acquiring, from wireless signals broadcast by other base station devices, information of one or more first base station devices, among the plurality of base station devices, in a vicinity of the base station device;
extracting, from ledger information of the blockchain, information of one or more second base station devices, among the plurality of base station devices, from or to which the terminal device is likely to transition to or from the one or more first base station devices; and
acquiring connection conditions of the one or more first base station devices and the one or more second base station devices from the ledger information of the blockchain, and determining the connection condition of the base station device on the basis of the acquired connection conditions.

6. A base station device as each of a plurality of base station devices included in a wireless communication system, the base station device comprising:
a memory; and
a processor coupled to the memory and configured to:
manage information regarding connection with a terminal device by using a blockchain shared by the plurality of base station devices;
acquire, from wireless signals broadcast by other base station devices, information of one or more first base station devices, among the plurality of base station devices, in a vicinity of the base station device;
extract, from ledger information of the blockchain, information of one or more second base station devices, among the plurality of base station devices, from or to which the terminal device is likely to transition to or from the one or more first base station devices; and
acquire connection conditions of the one or more first base station devices and the one or more second base station devices from the ledger information of the blockchain, and determine a connection condition of the base station device on the basis of the acquired connection conditions.
